(19) United States
(12) Patent Application Publication
(10) Pub. No.: US 2021/0224931 A1
(43) Pub. Date: Jul. 22, 2021

(54) METHODS, DEVICES, SYSTEMS AND COMPUTER PROGRAM PRODUCTS WHICH RELATE TO TRAVEL ARRANGEMENTS

(71) Applicant: SKYSCANNER LIMITED, London (GB)

(72) Inventors: Ross MCNAIRN, Edinburgh (GB); Edward TAYLOR, Edinburgh (GB)

(21) Appl. No.: 17/222,216

(22) Filed: Apr. 5, 2021

Related U.S. Application Data
(63) Continuation of application No. 15/557,556, filed on Sep. 12, 2017, now abandoned.

(30) Foreign Application Priority Data
Mar. 12, 2015 (GB) 1504160.1
Mar. 12, 2015 (GB) 1504226.0
Jul. 16, 2015 (GB) 1512418.3
Jul. 29, 2015 (GB) 1513317.6

(51) Int. Cl. G06Q 50/14; G06Q 10/10; G06Q 10/02; G06Q 30/06

(52) U.S. Cl. CPC G06Q 50/14; G06Q 10/109; G06F 3/0482; G06Q 10/025; G06Q 30/0625; G06Q 10/02

(57) ABSTRACT

There is provided a computer-implemented method of providing an itinerary search result, the method including the steps of: (i) presenting in a computing device user interface events proximate to a selected date, wherein the events are obtained from a calendar on the device; (ii) providing a selectable option in the user interface to select an itinerary search corresponding at least in part to the presented calendar events; (iii) receiving a selection of the selectable option; (iv) sending an itinerary search request to a server; (v) receiving an itinerary search result from the server, and (vi) presenting the itinerary search result in the user interface on the device. Related devices, systems and computer program products are disclosed. Further methods, devices, systems, servers and computer program products which relate to travel arrangements are disclosed.

### CROSS REFERENCE TO RELATED APPLICATIONS

This application is a continuation of U.S. application Ser. No. 15/557,556, filed on Sep. 12, 2017, which claims the priority of PCT/GB2016/050688, filed on Mar. 11, 2016, which claims priority to GB Application Nos. 1504160.1, filed Mar. 12, 2015; 1504226.0, filed Mar. 12, 2015; 1512418.3, filed Jul. 16, 2015; and 1513317.6, filed Jul. 29, 2015, the entire contents of each of which are incorporated fully herein by reference.

### BACKGROUND OF THE INVENTION

### 1. Field of the Invention

The field of the invention relates to computer-implemented methods, devices, systems, servers and computer program products which relate to travel arrangements.

### 2. Technical Background

Calendaring software is software that provides users with an electronic version of a calendar. The software may additionally provide an appointment book, address book, and/or contact list.

The software may be a networked package that allows for the sharing of information between users (e.g. Mozilla Sunbird, Windows Live Calendar, Google Calendar, or Microsoft Outlook with Exchange Server).

The following patent application disclosures are incorporated by reference: PCT/GB2014/052846, PCT/GB2013/053261, EP 2088544 and U.S. application Ser. No. 14/103,016.

### 3. Discussion of Related Art

Calendar software may use a computer file format which facilitates the sharing of calendar information, and related information, across devices and/or platforms. An example is iCalendar. iCalendar is a computer file format which allows Internet users to send meeting requests and tasks to other Internet users, via email, or sharing files with an extension of .ics. Recipients of the iCalendar data file (with supporting software, such as an email client or calendar application) can respond to the sender easily or counter-propose another meeting date/time.

iCalendar was created by the Internet Engineering Task Force Calendaring and Scheduling Working Group, and was authored by Frank Dawson of Lotus Development Corporation and Derik Stenerson of Microsoft Corporation. RFC 5545 provides a definition of the standard. iCalendar data has a Multipurpose Internet Mail Extensions (MIME) content type text/calendar. RFC 5545 includes the possibility of Property Parameters (eg. Group or List Membership information of a user), a possibility for Descriptive Component Properties (eg. information related to the global position for the activity specified by a calendar component), date and time related information in calendar components, and information specifying relationship information in calendar components (eg. attendee, contact).

When a user views a calendar on a device, they may observe that they need to travel to an upcoming meeting, hence travel arrangements will be required to be made for them to travel. A user may search and book the arrangements by himself, but this may cause problems if he needs to travel with others, who may face constraints on their travel arrangements. A group of travellers may need to correspond by email, or discuss by telephone, for example, in order to decide if they can travel together. By the time an agreement has been reached, ticket availability (such as on a plane, or a train, or a ferry) or room availability (such as in a hotel) may have changed to being no longer available. Hence a further round of discussions may be required. It is desirable to facilitate travel arrangement for users of devices; the devices may include a calendar function.

EP1280367B1 discloses a method of transferring electronic calendar data between a first device (MS1) and a second device (MS2), the second device (MS2) being remote from the first device (MS1), and both the first and second device being one of a mobile station capable of communicating over a mobile communications network and of a computer having a connection to the mobile communications network. The method comprises transmitting a calendar reservation from the first device (MS1) to the second device (MS2) via at least one mobile communications network, the calendar reservation including a subject and time of an event, receiving said calendar reservation at the second device, and storing the subject of the event of said received calendar reservation at the time of the event in an electronic calendar of the second device.

### SUMMARY OF THE INVENTION

### Summary of Invention 1

(i) Access is granted to the users cloud calendar provider (typically a third party);

(ii) Changes made to the users cloud calendar are observed, or we are notified of them by way of an HTTP callback;

(iii) Event changes cross referenced with user data e.g. city of location to qualify the likelihood of travel being required;

(iv) Qualifying events are articulated into one or many proposed itineraries capable of completing the predicted trip. (we want to keep the scope of this itinerization wide—ranging from do you need a trip to London—to a fully fledged perfect trip with the correct flights etc—this is why step (iii) and the use of personal data is so critical. Location/Personal loyalty points/company policy/past behaviour are all factors);

(v) The proposed itineraries set is pushed to the user via one of a variety of vectors. (email, mobile device, desktop notification).

### Summary of Invention 2

(i) Access is granted to the users native calendar on their mobile device.

(ii) At the point of selecting the date range of their flight or hotel they have potentially relevant calendar events displayed. (relevance may be determined temporally) (this may be the wireframe of the calendar+events).

### Summary of Invention 3

(i) Access is granted to the users native calendar on their mobile device;

(ii) Once the user has selected the components of their travel itinerary the user is presented with the option of notifying the attendees of the meetings that overlap with their trip;

(iii) The email address of the selected attendees is extracted from the Events on the native calendar.

### Summary of Invention 4

(i) A server receives from a user device a calendar event including a first location, and an indication of a second location, which may be the location of the user device;

(ii) the server performs an itinerary search based on the calendar event and the second location, and generates itinerary search results, and

(iii) the server sends a push notification including an itinerary search result to the user device.

Various aspects of the invention are presented below. Aspects of the invention may be combined.

According to a first aspect of the invention, there is provided a computer-implemented method of providing an itinerary search result, the method including the steps of:

(i) presenting in a device user interface events proximate to a selected date, wherein the events are obtained from a calendar on the device;

(ii) providing a selectable option in the user interface to select an itinerary search corresponding at least in part to the presented calendar events;

(iii) receiving a selection of the selectable option;

(iv) sending an itinerary search request to a server;

(v) receiving an itinerary search result from the server, and

(vi) presenting the itinerary search result in the user interface on the device.

Events proximate to a selected date are events on the selected date, or near to the selected date. An advantage is that the device operates in a new way, because the device is able to present itinerary search results in relation to calendar events obtained from a calendar on the device. A further advantage is reduced scope for data entry errors which could result if a user manually entered some data in an itinerary search interface after viewing an event in their device calendar.

The method may be one wherein step (iv) includes sending at least one calendar event from the device.

The method may be one wherein in steps (v) and (vi) a plurality of itinerary search results are received and presented.

The method may be one further including step (vii) in which a selectable option is provided in the user interface to request booking of a trip.

The method may be one further including step (viii) in which a selection of a booking request for a trip is received.

The method may be one wherein the device user interface includes a touch screen.

The method may be one wherein the device includes a processor.

The method may be one wherein the device is a mobile device.

The method may be one wherein mobile device is a smartphone.

The method may be one wherein the server is a remote server.

The method may be one wherein the server includes a processor.

According to a second aspect of the invention, there is provided a computing device programmed to perform a method of any aspect of the first aspect of the invention.

According to a third aspect of the invention, there is provided a system including a server and a computing device configured to communicate with the server, the device configured to:

(i) present in a device user interface events proximate to a selected date, wherein the events are obtained from a calendar on the device;

(ii) provide a selectable option in the user interface to select an itinerary search corresponding at least in part to the presented calendar events;

(iii) receive a selection of the selectable option;

(iv) send an itinerary search request to the server;

(v) receive an itinerary search result from the server, and

(vi) present the itinerary search result in the user interface on the device.

According to a fourth aspect of the invention, there is provided a computer program product executable on a device to perform a method of any aspect of the first aspect of the invention.

According to a fifth aspect of the invention, there is provided a computer-implemented method of sharing an itinerary search result with a calendar event attendee, including the steps of:

(i) receiving an itinerary search result at a computing device, in response to sending a request for an itinerary search to a server;

(ii) presenting a list of attendees from at least one event that overlaps with the itinerary search result, wherein the event is obtained from a calendar on the device;

(iii) receiving a selection of an attendee from the list to share the itinerary search result with;

(iv) sending a communication to the selected attendee, in which the communication shares the itinerary search result with the selected attendee.

An advantage is that the method has a technical effect on a process which is carried out outside the computer, because an itinerary search result is shared with a selected calendar event attendee who is not the operator of the device. A further advantage is that an itinerary search result can be shared between meeting attendees, which is expected to make arranging travel to an event easier.

The method may be one wherein in step (i) a plurality of itinerary search results are received and presented, and in step (iii) the shared itinerary search result is selected from the plurality of itinerary search results.

The method may be one further including step (v) in which a selectable option is provided in the user interface to request booking of a trip.

The method may be one further including step (vi) in which a selection of a booking request for a trip is received.

The method may be one including a step of receiving permission to access a calendar on the device.

The method may be one wherein step (ii) includes a step of presenting in the list the attendee identities and the meetings that fall in the itinerary period.

The method may be one wherein the device user interface includes a touch screen.

The method may be one wherein the device includes a processor.

The method may be one wherein the device is a mobile device.

The method may be one wherein the mobile device is a smartphone.

The method may be one wherein the server is a remote server.

The method may be one wherein the server includes a processor.

The method may be one wherein the method further includes a method of any aspect of the first aspect of the invention.

According to a sixth aspect of the invention, there is provided a computing device programmed to perform a method of any aspect of the fifth aspect of the invention.

According to a seventh aspect of the invention, there is provided a system including a server, a user computing device configured to communicate with the server, and a selected attendee computing device configured to communicate with the user device, wherein the user device is configured to:

(i) receive an itinerary search result at the user device, in response to sending a request for an itinerary search to the server;

(ii) present a list of attendees from at least one event that overlaps with the itinerary search result, wherein the event is obtained from a calendar on the user device;

(iii) receive a selection of an attendee from the list to share the itinerary search result with;

(iv) send a communication to the selected attendee device, in which the communication shares the itinerary search result with the selected attendee device.

According to an eighth aspect of the invention, there is provided a computer program product executable on a device to perform a method of any aspect of the fifth aspect of the invention.

According to a ninth aspect of the invention, there is provided a computer-implemented method of contextual planning using a calendar on a server, the method including the steps of:

(i) receiving an accepted calendar event at the server from a user;

(ii) receiving a location associated with the user;

(iii) evaluating a likelihood of the user requiring a trip from the location to the event;

(iv) in response to the likelihood exceeding a threshold, obtaining an itinerary search result for the trip, and

(v) sending the itinerary search result to the user.

An advantage is that the server operates in a new way, because the server is able to send itinerary search results in relation to a received calendar event obtained from a user. A further advantage is that the method has a technical effect on a process which is carried out outside the computer, because an itinerary search result is sent to a user who has accepted a calendar event.

The method may be one wherein step (v) includes also sending a selectable option to request booking of the trip.

The method may be one wherein in step (v), a communication is sent to the user by email, push, sms, web or text.

The method may be one wherein in step (v), a communication is sent to a smartphone of the user.

The method may be one further including step (vi) in which a selection of a booking request for a trip is received.

The method may be one wherein in step (iii), a distance from the location to the event is evaluated.

The method may be one wherein in step (iii) evaluating a likelihood comprises calculating a probability.

The method may be one wherein in steps (iv) and (v) a plurality of itinerary search results are obtained and sent.

The method may be one wherein in step (iv) an itinerary search is obtained using Skyscanner technology.

The method may be one wherein Skyscanner technology is a Skyscanner itinerary generator.

The method may be one wherein in step (iv) an itinerary search is obtained according to preferences and a policy.

The method may be one wherein the location associated with the user is saved at the server.

The method may be one wherein the server provides Authentication, Observation and Filtering.

The method may be one wherein the server provides Multi Factor Itinerary Generation.

The method may be one wherein the server is a remote server.

The method may be one wherein the server includes a processor.

The method may be one wherein all method steps are performed at the server.

The method may be one wherein the method further includes a method of any aspect of the fifth aspect of the invention, or wherein the method further includes a method of any aspect of the first aspect of the invention.

According to an tenth aspect of the invention, there is provided a server programmed to perform a method of any aspect of the ninth aspect of the invention.

According to an eleventh aspect of the invention, there is provided a system including a server and a user computing device configured to communicate with the server, the user device including an application configured to communicate an accepted calendar event to the server, wherein the server is configured to provide contextual planning using a calendar on the server, wherein the server is configured to:

(i) receive an accepted calendar event from the user device;

(ii) receive a location associated with the user device;

(iii) evaluate a likelihood of a user of the user device requiring a trip from the location to the event;

(iv) in response to the likelihood exceeding a threshold, obtain an itinerary search result for the trip, and

(v) send the itinerary search result to the user device.

According to a twelfth aspect of the invention, there is provided a computer program product executable on a server to perform a method of any aspect of the ninth aspect of the invention.

According to a thirteenth aspect of the invention, there is provided a computer-implemented method of providing automated collaboration between a traveller and a booker, the method including the steps of:

(i) receiving at a server an indication of a desired trip from the traveller;

(ii) obtaining an itinerary search result in response to receipt of the indicated desired trip;

(iii) sending the itinerary search result to the booker, each result having a corresponding selectable option using which the booker may book the search result;

(iv) receiving a selection of a search result from the booker, and

(v) arranging for booking of the search result.

An advantage is that the method has a technical effect on a process which is carried out outside the computer, because automated collaboration between a traveller and a booker is provided.

The method may be one wherein the indication of a desired trip from the traveller includes trip components selected and built by the traveller.

The method may be one wherein if the booker is not registered on the server, the booker is prompted to signup.

The method may be one wherein step (i) includes receiving an email address or mobile phone number of a booker from the traveller, for communication with the booker.

The method may be one wherein in step (iii), a notification is sent to the booker by email, push, sms, web or text.

The method may be one wherein in step (iii), a notification is sent to a smartphone of a booker.

The method may be one wherein in steps (ii) and (iii) a plurality of itinerary search results are obtained and sent.

The method may be one wherein the booker automatically receives availability and prices of options.

The method may be one wherein the booker receives a clickable re-direct to a best or cheapest available price for that option.

The method may be one wherein the clickable re-direct is a 1-click re-direct.

The method may be one wherein in step (ii) an itinerary search is obtained using Skyscanner technology.

The method may be one wherein Skyscanner technology is a Skyscanner itinerary generator.

The method may be one wherein in step (ii) an itinerary search is obtained according to preferences and a policy.

The method may be one wherein if the booker is signed up at the server, bookings approved by the booker are stored in a server account associated with the booker, and the account is viewable by the booker.

The method may be one further including step (vi) in which the traveller is notified of the booking.

The method may be one wherein step (vi) further includes the traveller receiving a calendar entry relating to the booking.

The method may be one wherein the traveller and the booker are in the same organization.

The method may be one wherein the traveller and the booker are not in the same organization.

The method may be one wherein the server provides Authentication, Observation and Filtering.

The method may be one wherein the server provides Multi Factor Itinerary Generation.

The method may be one wherein the server is a remote server.

The method may be one wherein the server includes a processor.

The method may be one wherein all method steps are performed at the server.

The method may be one which further includes a method of any aspect of the ninth aspect of the invention, or wherein the method further includes a method of any aspect of the fifth aspect of the invention, or wherein the method further includes a method of any of aspect of the first aspect of the invention.

According to a fourteenth aspect of the invention, there is provided a server programmed to perform a method of any of aspect of the thirteenth aspect of the invention.

According to a fifteenth aspect of the invention, there is provided a system including a server, a traveller computing device configured to communicate with the server, and a booker computing device configured to communicate with the server, wherein the server is configured to provide automated collaboration between a traveller device user and a booker device user, wherein the server is configured to:

(i) receive an indication of a desired trip from the traveller device;

(ii) obtain an itinerary search result in response to receipt of the indicated desired trip;

(iii) send the itinerary search result to the booker device, each result having a corresponding selectable option using which a booker device user may book the search result;

(iv) receive a selection of a search result from the booker device, and

(v) arrange for booking of the search result.

According to a sixteenth aspect of the invention, there is provided a computer program product executable on a server to perform a method of any aspect of the thirteenth aspect of the invention.

According to a seventeenth aspect of the invention, there is provided a computer-implemented method of providing group travel data for a group of individuals, the method including the steps of:

(i) receiving at a server an indication of a group of individuals;

(ii) receiving an indication of a travel itinerary for at least one member of the group;

(iii) receiving a request from an individual in the group for travel itinerary data for at least one other group member, and

(iv) in response to the request, sending the requested data to the individual who sent the request.

An advantage is that the method has a technical effect on a process which is carried out outside the computer, because travel data is provided to an individual in a group for travel itinerary data for at least one other group member.

The method may be one further including the step of: (v) in response to a request from a user with a travel itinerary, presenting a list of other group members in which group members are selectable to be included in the travel itinerary of the user with the travel itinerary. An advantage is that the method has a technical effect on a process which is carried out outside the computer, because group members are selectable to be included in the travel itinerary of the user with the travel itinerary, which permits one individual to turn his own travel arrangement into a travel arrangement for other members of the group, without having to make multiple further bookings.

The method may be one wherein a traveller may copy parts of another traveller's trip.

The method may be one wherein in step (iv), in response to the request, also sending a selectable option to request booking of the trip.

The method may be one wherein in step (iv), a communication is sent to the individual by email, push, sms, web or text.

The method may be one wherein in step (iv), a communication is sent to a smartphone of the individual.

The method may be one further including a step in which a selection of a booking request for a trip is received from the individual.

The method may be one further including a step in which the individual is notified of the booking.

The method may be one wherein the step further includes the individual receiving a calendar entry relating to the booking.

The method may be one wherein the server provides Authentication, Observation and Filtering.

The method may be one wherein the server provides Multi Factor Itinerary Generation.

The method may be one wherein a location associated with the individual is saved at the server.

The method may be one wherein the server is a remote server.

The method may be one wherein the server includes a processor.

The method may be one wherein all method steps are performed at the server.

The method may be one wherein the method further includes a method of any aspect of the thirteenth aspect of the invention or the method further includes a method of any aspect of the ninth aspect of the invention, or wherein the method further includes a method of any aspect of the fifth aspect of the invention, or wherein the method further includes a method of any of aspect of the first aspect of the invention.

According to an eighteenth aspect of the invention, there is provided a server programmed to perform a method of any aspect of the seventeenth aspect of the invention.

According to a nineteenth aspect of the invention, there is provided a system including a server, a first group member computing device configured to communicate with the server, and a second group member computing device configured to communicate with the server, the system configured to provide group travel data for a group of individuals, the server configured to:

(i) receive an indication of a group of individuals;

(ii) receive an indication of a travel itinerary from the first group member device;

(iii) receive a request from the second group member device for travel itinerary data for at least one group member other than the second group member, and

(iv) in response to the request, send the requested data to the second group member device.

According to a twentieth aspect of the invention, there is provided a computer program product executable on a server to perform a method of any aspect of the seventeenth aspect of the invention.

According to a 21st aspect of the invention, there is provided a computer-implemented method of sending a push notification to a user computing device relating to travel planning, the method including the steps of:

(i) receiving at a server from the user device a calendar event including a first location, and an indication of a second location;

(ii) performing at the server an itinerary search based on the calendar event and the second location, and generating itinerary search results, and

(iii) sending a push notification including an itinerary search result to the user device.

An advantage is that the server and user computing device operate in a new way, because the device is able to receive and to present itinerary search results in relation to calendar events on a calendar on the device, without having to explicitly request the search results. A further advantage is reduced scope for data entry errors which could result if a user manually entered some data in an itinerary search interface after viewing an event in their device calendar. A further advantage is that the server operates in a new way, because the server is able to send itinerary search results in relation to a received calendar event received from a user device.

The method may be one wherein the second location is a location of the user device.

The method may be one wherein the method includes the step of the server receiving a user authorization to receive and to use the user's calendar events to be sent to the server.

The method may be one wherein the method includes the step of a plurality of people authorising their calendar events to be sent to the server.

The method may be one wherein the user device is a mobile device.

The method may be one wherein the push notification includes a call to travel planning action.

The method may be one wherein the push notification offers travel flight booking.

The method may be one wherein the push notification offers hotel booking.

The method may be one wherein the calendar event is for a plurality of people.

The method may be one wherein the time between steps (i) and (iii) is of a predetermined duration, or in a predetermined duration range.

The method may be one in which sending a push notification including an itinerary search result to the user device includes the step of sending a push notification including a plurality of itinerary search results to the user device.

According to a 22nd aspect of the invention, there is provided a user computing device including an application operable to communicate with a server, the application configured to send to the server a calendar event including a first location, and an indication of a second location, and the application configured to receive from the server a push notification including an itinerary search result based on the calendar event and the second location.

The device may be one wherein the second location is a location of the user device.

The device may be one wherein the user device is a mobile device.

The device may be one wherein the application is configured to ask the user of the user device if he agrees to integrate his calendar with a push notification service, and if the user agrees, the application sends to the server a user authorization to receive and to use their calendar events at the server.

The device may be one wherein the application provides a trip creation process in response to user selection of the push notification.

The device may be one wherein the trip creation process offers travel flight booking and/or hotel booking.

According to a 23rd aspect of the invention, there is provided an application downloadable to a user device, the application configured to communicate with a server, the application configured to send to the server a calendar event including a first location, and an indication of a second location, and the application configured to receive from the server a push notification including an itinerary search result based on the calendar event and the second location.

The application may be one wherein the second location is a location of the user device.

According to a 24th aspect of the invention, there is provided a server configured to send a push notification to a user computing device relating to travel planning, the server configured to:

(i) receive from the user device a calendar event including a first location, and an indication of a second location;

(ii) perform an itinerary search based on the calendar event and the second location, and generating itinerary search results, and

(iii) send a push notification including an itinerary search result to the user device.

The server may be one wherein the second location is a location of the user device.

According to a 25th aspect of the invention, there is provided a system including a server and a user computing device, wherein the server is configured to send a push notification to the user device relating to travel planning, the server configured to:

(i) receive from the user device a calendar event including a first location, and an indication of a second location;

(ii) perform an itinerary search based on the calendar event and the second location, and generating itinerary search results, and

(iii) send a push notification including an itinerary search result to the user device, wherein the user device includes an application operable to communicate with the server, the application configured to send to the server the calendar event including a location, and an indication of the second location, and the application configured to receive from the server the push notification including an itinerary search result based on the calendar event and the second location.

The system may be one wherein the second location is a location of the user device.

According to a 26th aspect of the invention, there is provided a computer-implemented method of visually differentiating itinerary search result list items for which an organization has negotiated special rates, the method including the steps of:

(i) receiving at a server an indication of a desired trip from a traveller;

(ii) receiving at the server an indication of an organization of which the traveller is a member;

(iii) obtaining an itinerary search result in response to receipt of the indicated desired trip;

(iv) comparing each itinerary search result with a list identifying items for which the organization has negotiated special rates;

(v) sending the itinerary search result to the traveller, each result identifying whether or not it is one for which the organization has negotiated special rates, and each result having a corresponding selectable option using which the traveller may book the search result;

(vi) receiving a selection of a search result from the traveller.

The method may be one in which the accommodations for which the organization has negotiated special rates are always listed first, with an easy to notice visual differentiation.

According to a 27th aspect of the invention, there is provided a computer-implemented method of indicating that a member of the same organization as the traveller has booked to stay at or has stayed at accommodations, on a list of accommodation items, the method including the steps of:

(i) receiving at a server an indication of a desired accommodation from a traveller;

(ii) receiving at the server an indication of an organization of which the traveller is a member;

(iii) identifying a list of accommodations booked by or used by members of the organization;

(iv) obtaining an accommodation search result in response to receipt of the indicated desired accommodation;

(v) comparing each accommodation search result with the list of accommodations booked by or used by the members of the organization;

(vi) sending the accommodation search result to the traveller, each result identifying members of the organization who have booked to stay at or have stayed at accommodations in the search results, and each result having a corresponding selectable option using which the traveller may book the search result, and

(vii) receiving a selection of a search result from the traveller.

The method may be one in which the traveller can very easily see which are the accommodations that someone at her organization has booked at any point in the past.

According to a 28th aspect of the invention, there is provided a computer-implemented method of indicating that a member of the same organization as the traveller has booked to use, or has used, a flight, on a list of flight items, the method including the steps of:

(i) receiving at a server an indication of a desired flight from a traveller;

(ii) receiving at the server an indication of an organization of which the traveller is a member;

(iii) identifying a list of flights booked by or used by members of the organization;

(iv) obtaining a flight search result in response to receipt of the indicated desired flight;

(v) comparing each flight search result with the list of flights booked by or used by the members of the organization;

(vi) sending the flight search result to the traveller, each result identifying members of the organization who have booked to use or have used flights in the search results, and each result having a corresponding selectable option using which the traveller may book the search result, and

(vii) receiving a selection of a search result from the traveller.

The method may be one in which each result identifying members of the organization who have booked to use or have used flights in the search results does so by showing their photos or names on the respective result.

The method may be one in which the traveller can very easily see which are the flights that someone at her organization has booked at any point in the past.

According to a 29th aspect of the invention, there is provided a computer-implemented method of sorting a list of accommodation items based on their distance from the company office of the traveller in the city where these accommodations are located, the method including the steps of:

(i) receiving at a server an indication of a desired accommodation and a desired city from a traveller;

(ii) receiving at the server an indication of an organization of which the traveller is a member;

(iii) identifying an office location for the organization in the desired city;

(iv) obtaining an accommodation search result in response to receipt of the indicated desired accommodation and desired city;

(v) calculating a distance between each accommodation search result and the office location for the organization in the city;

(vi) sending the accommodation search results to the traveller, as a list ordered by their distance from the company office of the traveller in the desired city where these accommodations are located, and each result having a corresponding selectable option using which the traveller may book the search result;

(vii) receiving a selection of a search result from the traveller.

The method may be one in which the step of identifying an office location for the organization in the desired city including: if the organization has multiple offices in the desired city, providing a list of the multiple offices in the desired city and receiving a selection of the desired office in the desired city.

According to a 30th aspect of the invention, there is provided a computer-implemented method of indicating that a flight item is within a flights policy of an organization of a traveller, the method including the steps of:

(i) receiving at a server an indication of a desired flight from a traveller;

(ii) receiving at the server an indication of an organization of which the traveller is a member;

(iii) identifying a set of flights policies of the organization;

(iv) obtaining a flight search result in response to receipt of the indicated desired flight;

(v) comparing each flight search result with the set of flights policies of the organization;

(vi) sending the flight search result to the traveller, each result identifying compliance or non-compliance of the result with the set of flights policies of the organization, and each result having a corresponding selectable option using which the traveller may book the search result, and

(vii) receiving a selection of a search result from the traveller.

The method may further comprise the step of: if the selected result is non-compliant, providing an input for the traveller to explain why they have selected a non-compliant result.

The method may be one in which the set of flights policies of the organization identifies flights that have all their parameters—cabin class and price—within the bounds that the organization specified.

The method may be one in which compliant flight results are visually easily differentiated from non-compliant flight results.

According to a 31st aspect of the invention, there is provided a computer-implemented method of indicating that a rail travel item is within a rail travel policy of an organization of a traveller, the method including the steps of:

(i) receiving at a server an indication of a desired rail travel from a traveller;

(ii) receiving at the server an indication of an organization of which the traveller is a member;

(iii) identifying a set of rail travel policies of the organization;

(iv) obtaining a rail travel search result in response to receipt of the indicated desired rail travel;

(v) comparing each rail travel search result with the set of rail travel policies of the organization;

(vi) sending the rail travel search result to the traveller, each result identifying compliance or non-compliance of the result with the set of rail travel policies of the organization, and each result having a corresponding selectable option using which the traveller may book the search result;

(vii) receiving a selection of a search result from the traveller.

The method may further comprise the step of: if the selected result is non-compliant, providing an input for the traveller to explain why they have selected a non-compliant result.

The method may be one in which the set of rail travel policies of the organization identifies rail travel items that have all their parameters—seat class and price—within the bounds that the organization specified.

The method may be one in which compliant rail travel results are visually easily differentiated from non-compliant rail travel results.

According to a 32nd aspect of the invention, there is provided a computer-implemented method of indicating that an accommodation item is within an accommodation policy of an organization of a traveller, the method including the steps of:

(i) receiving at a server an indication of a desired accommodation from a traveller;

(ii) receiving at the server an indication of an organization of which the traveller is a member;

(iii) identifying a set of accommodation policies of the organization;

(iv) obtaining an accommodation search result in response to receipt of the indicated desired accommodation;

(v) comparing each accommodation search result with the set of accommodation policies of the organization;

(vi) sending the accommodation search result to the traveller, each result identifying compliance or non-compliance of the result with the set of accommodation policies of the organization, and each result having a corresponding selectable option using which the traveller may book the search result;

(vii) receiving a selection of a search result from the traveller.

The method may further comprise the step of: if the selected result is non-compliant, providing an input for the traveller to explain why they have selected a non-compliant result.

The method may be one in which the set of accommodation policies of the organization identifies accommodation items that have all their parameters within the bounds that the organization specified.

The method may be one in which compliant accommodation results are visually easily differentiated from non-compliant accommodation results.

According to a 33rd aspect of the invention, there is provided a computer-implemented method of suggesting people to invite who are in a user's calendar meetings and are native contacts of the user, the method including the steps of:

(i) receiving meeting calendar data relating to the user's calendar meetings;

(ii) searching the meeting calendar data to identify people in the user's calendar meetings;

(iii) receiving data relating to the native contacts of the user;

(iv) comparing the identified people in the user's calendar meetings with the data relating to the native contacts of the user, and

(v) providing a list of suggested people to invite to a calendar meeting who are in a user's calendar meetings and who are native contacts of the user.

According to a 34th aspect of the invention, there is provided a computer-implemented method of a traveller reviewing accommodation so that the review is only visible to members of the same organization as the traveller, the method including the steps of:

(i) receiving at a server a review of accommodation from a traveller;

(ii) receiving at the server an indication of an organization of which the traveller is a member;

(iii) storing the review at the server;

(iv) making the review available from the server only to members of the same organization as the traveller.

### BRIEF DESCRIPTION OF THE DRAWINGS

The above and other aspects of the invention will now be described, by way of example only, with reference to the following Figures, in which:

FIG. 1 shows an example of accessing a native mobile calendar to present event data at the point of date selection.

FIG. 2 shows a prior art organization travel booking process.

FIG. 3 shows an example of a party system in which organization members Share Itineraries, Discuss and copy options, Clone Trips, or Receive Travel-related Notifications.

FIG. 4 shows an example of a party system in which organization members may be segmented into groups related to travel arrangement, and Cross organization Pollination travel arrangement is achieved.

FIG. 5 shows an example of a party system in use on a smartphone.

FIG. 6 shows an example of a party system in use on a desktop or laptop computer screen.

FIG. 7 shows an example of a displayed email which a second user receives and which invites them to collaborate on a trip plan which has been created by a first user.

FIG. 8 shows an example of a trip planning platform providing a user interface for reporting of an organization's travel usage.

FIG. 9 shows an example of a traveller's request being channeled via a travel hub to an organization's travel admin, with an email communication being sent to an address in the organization's domain, which in this example is travel_admin@skyscanner.net.

FIG. 10 shows an example in which a traveller can edit a trip, which is bookable by a travel admin; the traveller can invite a second traveller to view the trip.

FIG. 11 shows an example in which Ross in Skyscanner offers a “book your travel link” to Peter, who is not in Skyscanner.

FIG. 12 shows an example of a person outside the organization (Peter); the organization has offered to book that person's travel (Peter's travel to Edinburgh).

FIG. 13 shows an example of when a supervisor (eg. Shane) looks at reports on the travel hub, he sees the booking his organization paid for, in the correct place.

FIG. 14 shows an example of a meeting invite and information contained in the invite.

FIG. 15 shows an example, in which an itinerary generator may be used by the travel hub to generate and to send possible itineraries to the traveller user, such as to their smartphone.

FIG. 16 shows an example in which three services may be provided by or via the travel hub.

FIG. 17 shows an example in which a Mobile Application will feed straight into the travel hub.

### DETAILED DESCRIPTION

Contextual Planning in a mobile device application is provided.

Accessing and extracting attendees from native calendar events may be performed, to present sharing and distribution. A purpose is to allow users to see the events that overlay with their proposed search, helping them to plan. A native mobile calendar may be accessed, to present event data at the point of date selection.

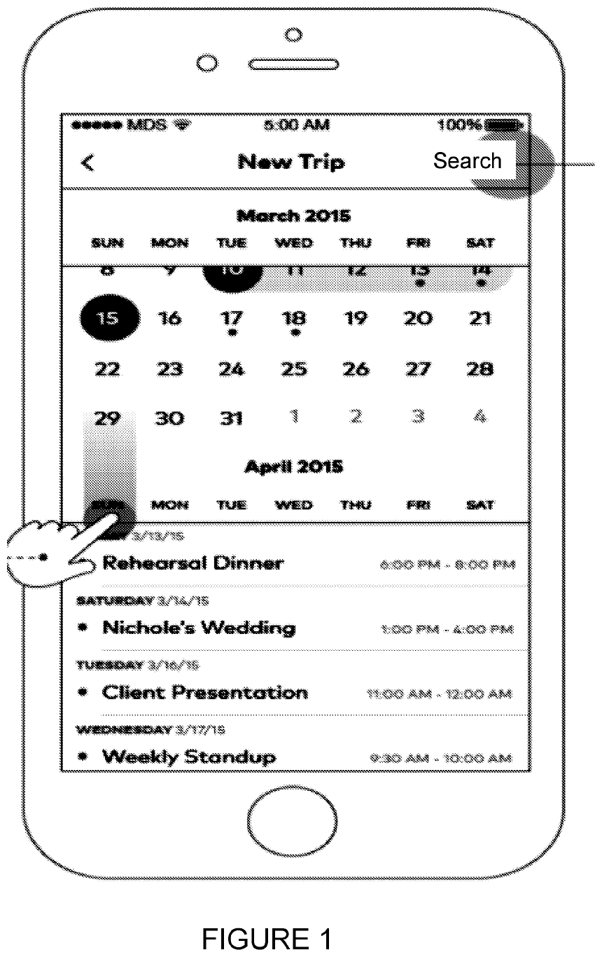

When a date in the calendar is selected, events proximate that day (i.e. on that day or near that day), may be displayed. An itinerary search (eg. for the selected date, or in the vicinity of the selected date) may be requested by selecting an option in the user interface on the device (eg. a mobile device). FIG. 1 shows an example of accessing a native mobile calendar to present event data at the point of date selection.

Contextual Sharing in a mobile device application is provided.

In a flow example:
Users provide access to their native (eg. iOS/Android) calendar.
A trip is prepared.
Users are presented with a list of attendees from events that overlap with their Trip. A list may show the user and the name of the meetings that fall over that period.
A user may be prompted to share plans with these relevant parties by selecting each user to share plans with.

Contextual planning from a cloud calendar is provided.

In a flow example:
A user accepts and adds events to a calendar (eg. cloud calendar).
A platform (eg. Skyscanner) observes changes in the calendar and cross references user data held by the accepting user on their location of residence.
The platform (eg. Skyscanner) calculates the probability of a trip being required.
The platform (eg. Skyscanner) engages the user through a given vector (email/push/text) with information on the potential trip.

A Meta Search Travel Booking Assistant is provided. This is a travel request process powered by meta search engine.

In a flow example:
Traveller builds and selects components of a trip.
Traveller submits given options to a platform (eg. Skyscanner).
the Platform notifies the booking party.
the Booking party receives a notification.
the Booking party automatically has availability and prices of options re-collected.
the Booking party receives a clickable (eg. 1 click) re-direct to a best or cheapest available price for that option.

A Meta Powered Flight Finder is provided.

In an example, there is specified a specific flight either by—minimum combination of [departure airport, arrival airport, departure time/date, arrival time/date, flight number, airline]. There is provided a meta search identification of cheapest price for that flight.

A Group Trip Planner is provided.

Multiple travellers may form part of the same “party”. In an example, all travellers can see each other's itineraries and add other travellers to the party. Travellers may “copy” parts of other traveller's trips, in an example.

### A Corporate Travel Service

A problem is that travel arrangement processes in small and medium size firms are inefficient compared with bigger firms. For example, bigger firms may have a specialist travel manager or procurement buyer. For example, bigger firms may have a specialist/global procurement travel buyer. But a small or medium size firm may have only an internal travel manager, or open booking.

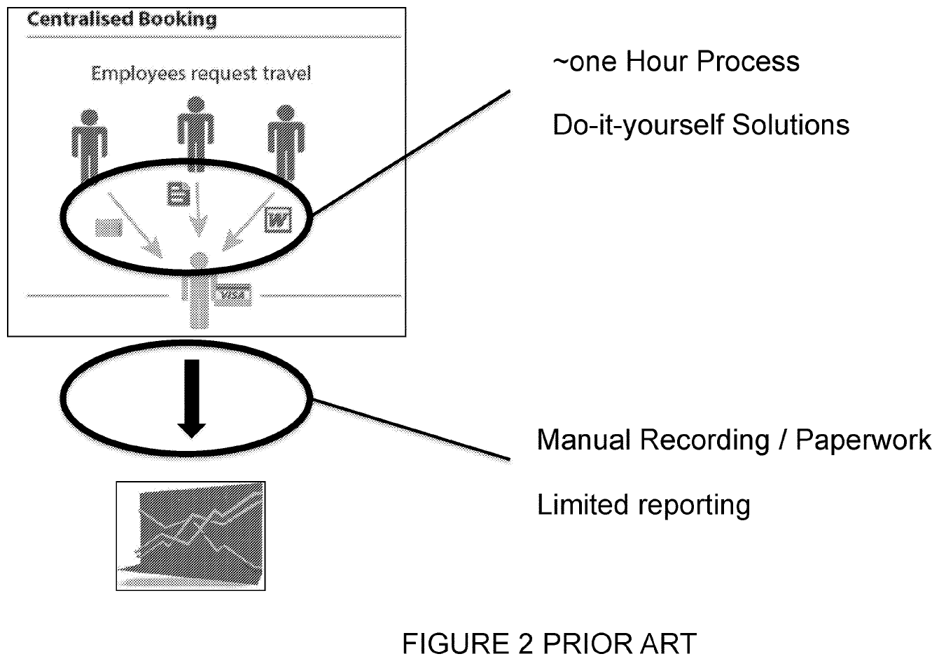

In a prior art organization travel booking process, organization members may request travel. There may then follow a process lasting about an hour, in which the organization members or their subordinates, research travel possibilities, and then book or request permission to book the travel. What follows is manual recording and paperwork, with limited reporting. An example is shown in FIG. 2.

In an initial solution, an organization administration unit may push a more formal solution into the rest of the organization.

Exponential growth may be achieved by getting further groups of organization members to engage in travel arrangement with an initial group of organization members who are planning travel, such as those organization members who may want to travel with the initial group, or such as those organization members who may be required to travel with the initial group.

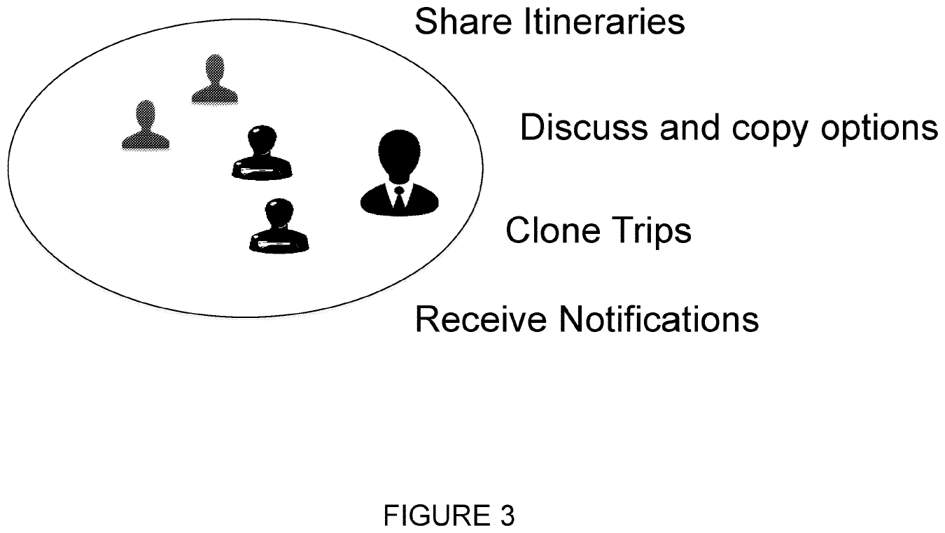

A party system may be created in which organization members Share Itineraries, Discuss and copy options, Clone Trips, or Receive Travel-related Notifications. An example is shown in FIG. 3.

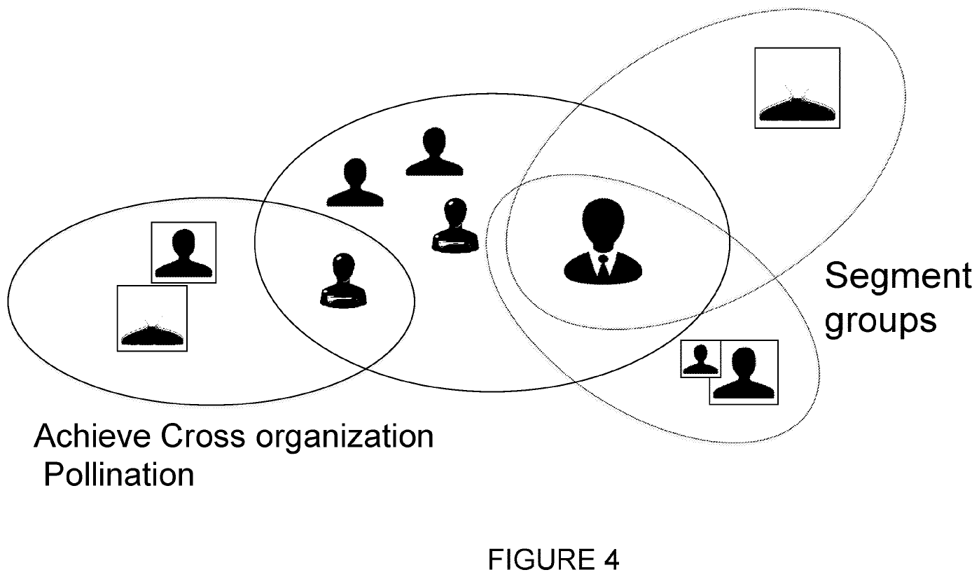

A party system may be created in which organization members may be segmented into groups related to travel arrangement, and Cross organization Pollination travel arrangement is achieved. An example is shown in FIG. 4.

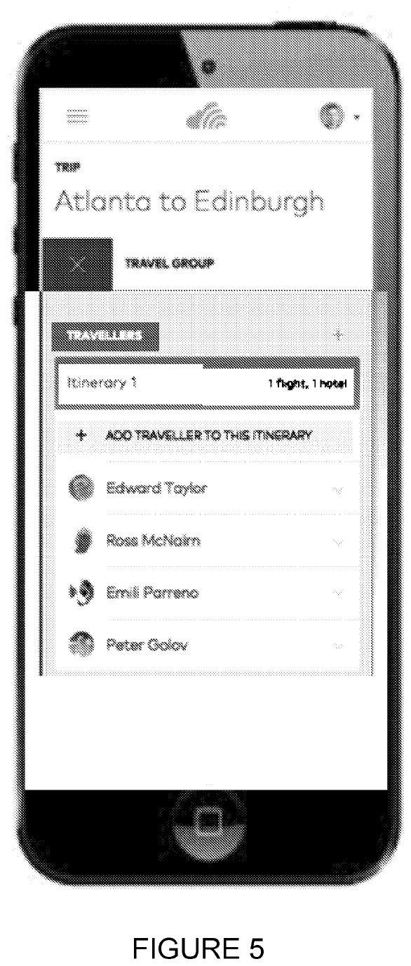

In an example, a user generates an itinerary which consists of an identified flight route (eg. Atlanta to Edinburgh) and a location for a stay in a hotel (eg. Edinburgh). A user interface is presented in which individuals are selectable (such as from a previously generated travel group) for invitation to, or for addition to, the itinerary. An example of a party system in use on a smartphone is shown in FIG. 5.

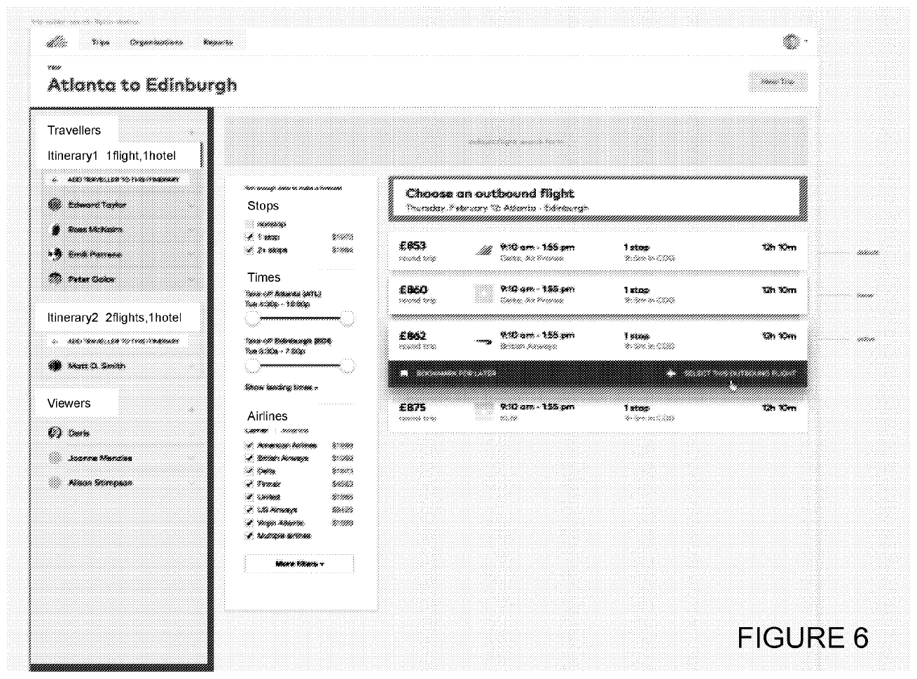

In an example, a user generates an itinerary which consists of an identified flight route (eg. Atlanta to Edinburgh) and a location for a stay in a hotel (eg. Edinburgh). A user interface is presented in which individuals are selectable (such as from a previously generated travel group) for invitation to, or for addition to, the itinerary. A list of candidate outbound flights may be provided, from which an individual flight may be selectable. A plurality of selectable generated itineraries may be provided in a user interface. A list of individuals permitted to view the travel arrangements may be displayed in the user interface. An example of a party system in use on a desktop or laptop computer screen is shown in FIG. 6.

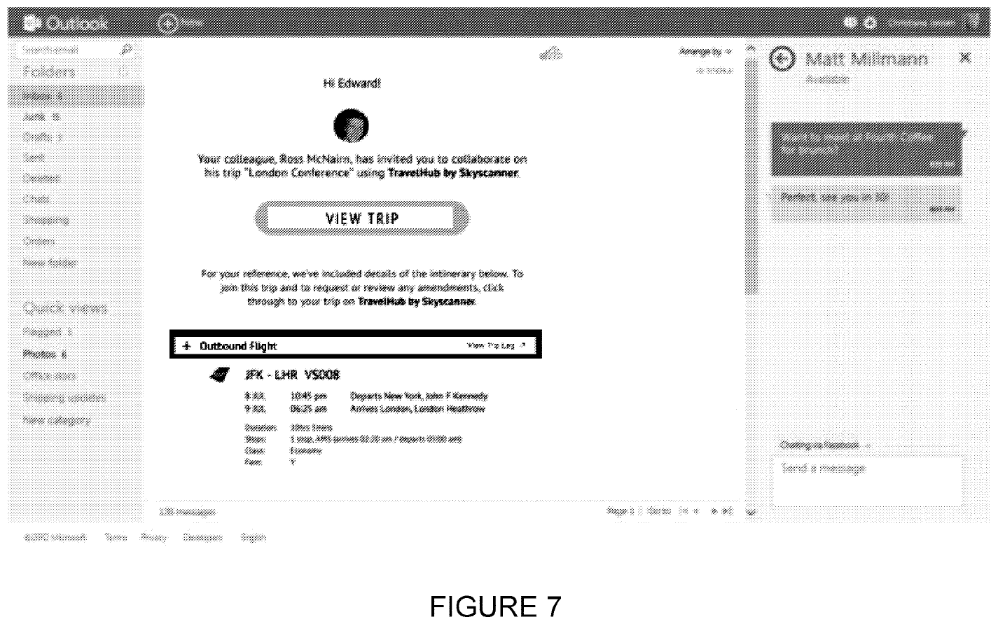

In an example, a second user receives and displays a message (eg. an email or text message) which invites them to collaborate on a trip plan which has been created by a first user. The message (eg. an email or text message) may include details of an itinerary, such as details of an outbound flight. An option may be presented in which the second user can click through to the trip plan provided by a trip plan operator on a trip planning platform. On the trip planning platform, the second user may be able to request or to review amendments to the trip plan. An example of a displayed email which a second user receives and which invites them to collaborate on a trip plan which has been created by a first user, is shown in FIG. 7.

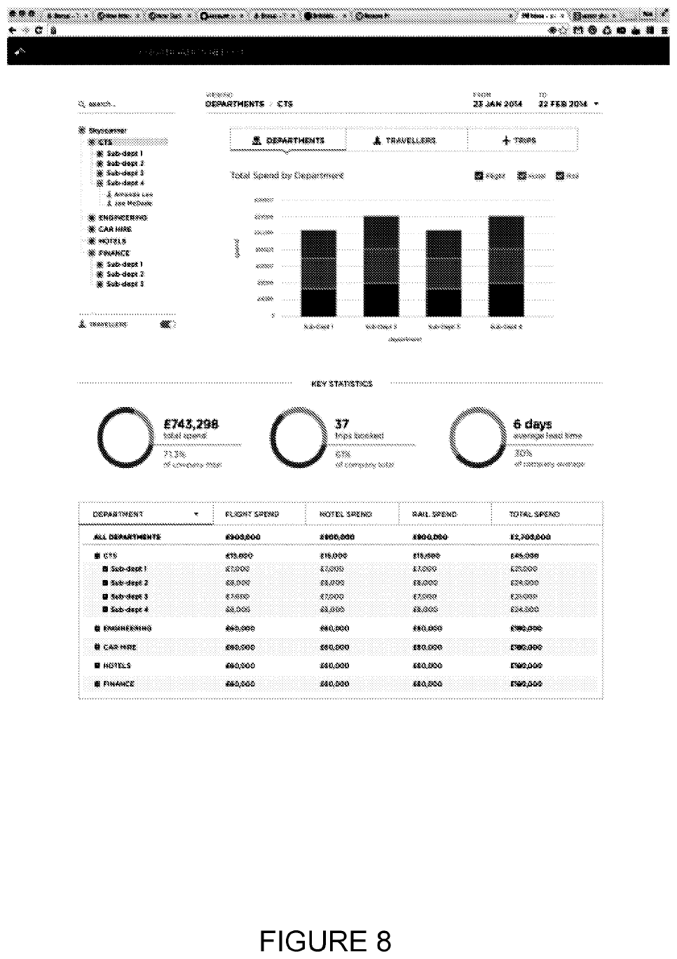

A trip planning platform may provide a user interface for reporting of an organization's travel usage, in which reporting may be provided over the internet. Reporting may be provided to a limited user group, eg. a finance department. Reporting may include spending by department, spending by user, or spending by trip. Department spending may be reported by sub-department. Spending may be broken down into categories such as rail, flights and hotels. A reporting interval may be identified, such as from a start date to an end date. Key statistics may be presented: examples are percentage of organization spend by a department, percentage of organization trips by a department, and average travel planning lead time for a department. An example of a trip planning platform providing a user interface for reporting of an organization's travel usage, in which reporting may be provided over the internet, is shown in FIG. 8.

### Corporate Travel System

In the prior art, typical referral mechanics are that a user wants to travel but the user wants someone else to book. So for example a traveller may research a trip and then send a request to travel admin to make the booking. Or a user who wants to travel may research a trip and then send himself a reminder to book later.

In a system, we start with someone else booking. A travel hub is provided. The travel hub may be a server connected via a network (eg. the internet) to a plurality of user terminals. The server may be real or virtual or in the Cloud. In an example, the travel hub is the anchor of Skyscanner's Corporate Travel Service: a hub for the storage/submissions and analysis of trips.

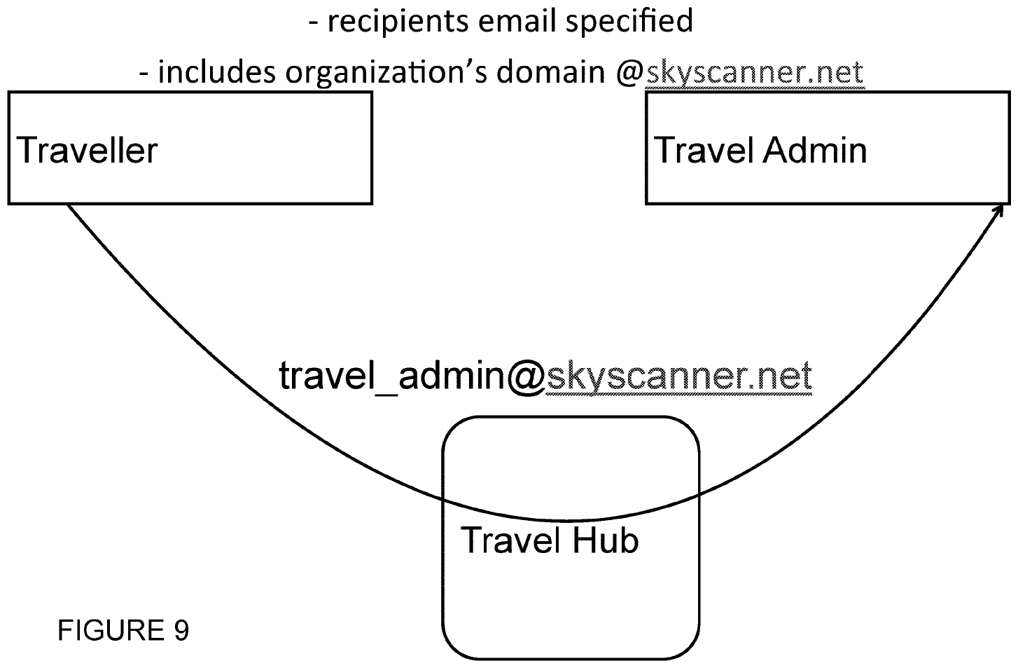

In an example, with a Traveller & Admin that are new to TravelHub, a new request is forwarded into TravelHub. There is a traveller who requests bookings, and an organization travel admin that processes bookings. The traveller's booking request is channeled via the travel hub to the organization's travel admin, with for example a communication being sent to the travel admin (e.g. email being sent to an address in the organization's domain). An example is shown in FIG. 9. In the example of FIG. 9, the traveller's request is channeled via the travel hub to an organization's travel admin, with an email communication being sent to an address in the organization's domain, which in this example is travel_admin@skyscanner.net. When the Travel Admin is notified of a booking, the Travel Admin is directed to the Travel Hub. If the Travel Admin is new to the travel hub service, before redirection to a booking site, the Travel Admin may be prompted to signup (eg. to register) (and optionally to store trips), or to return after booking to input a reference or price to the travel hub records, without signup. After a booking with a travel hub partner site is made, the Travel Admin may input a reference or price to the travel hub records. In a next step, the traveller is notified of the booking. The traveller may receive itinerary information relating to the booking. The traveller may receive one or a plurality of calendar entries relating to the booking. The travel admin may be able to receive an auto-reporting function of the booking, and of other bookings, from the travel hub, such as via a network (eg. internet) login to the travel hub. Information may therefore be stored to an organization, such as to the traveller's device or devices (eg. smartphone, tablet, laptop, desk top computer) and to the travel admin's account at the travel hub server.

Use of the travel hub service by an organization is expected to grow over time. An organization should be converted to using the service over time. For example, if multiple travellers make requests via the travel hub, a travel admin part of an organization will start to gain familiarity with the system. Even if the travel admin does not sign up on first usage, they may sign up after using the travel hub a few times. The travel admin may find they can execute their function in a much reduced time (eg. reduced to a tenth), and they may benefit from auto-reporting, because all the required information may be stored in one place, on the travel hub. The travel admin may then push usage onto further users inside the organization.

Spreading the adoption between organizations is possible, leading to mass adoption.

In the travel hub system, a traveller can share a first trip with other users, who may then generate their own trips based on the first trip. A traveller may be able to edit a trip. The travel admin may be able to book the trip.

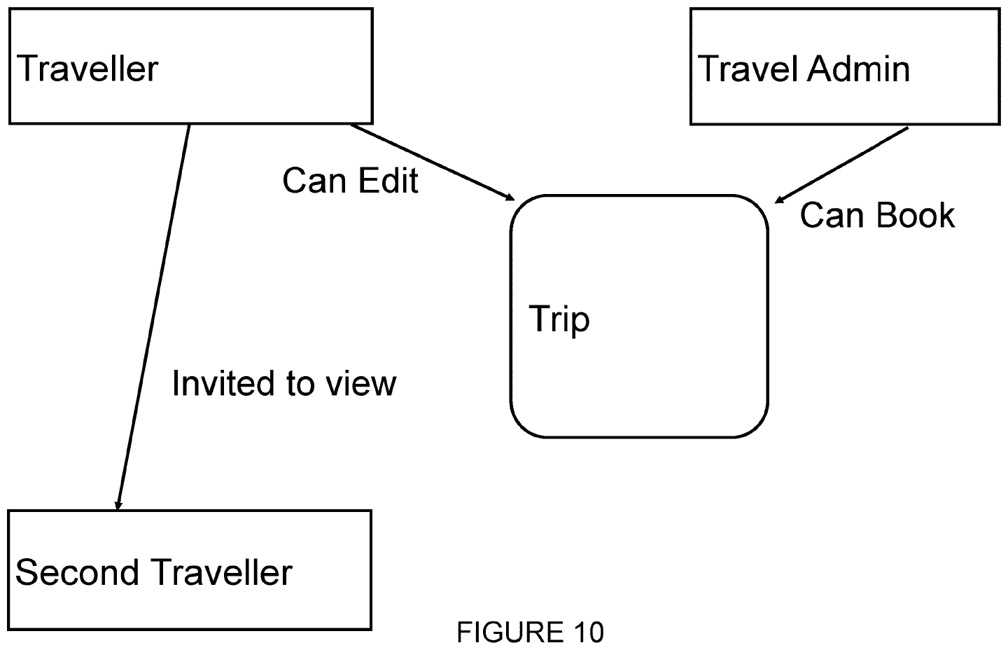

A traveller may be able to invite others, from other organizations. A traveller may be able to invite others, from other organizations, to view a trip. A traveller can edit a trip, which is bookable by a travel admin; the traveller can invite a second traveller from another organization to view the trip. The traveller may be able to invite a second traveller to view the trip, before or after the trip is booked. An example is shown in FIG. 10, in which a traveller can edit a trip, which is bookable by a travel admin; the traveller can invite a second traveller to view the trip. The traveller may be able to invite a second traveller to view the trip, before or after the trip is booked.

A traveller may be able to invite others, from other organizations. A traveller may be able to invite others, from other organizations, to view a trip. A traveller can edit a trip, which is bookable by a travel admin; the traveller can invite a second traveller from another organization to view the trip. The traveller may be able to invite a second traveller to view the trip, before or after the trip is booked by travel admin. The second traveller may be able to copy the trip, to create a second trip. The second traveller may be able to customize the components of the second trip. The second traveller may be able to invite a third traveller from another organization to view the second trip. The third traveller may be able to copy the second trip, to create a third trip. The third traveller may be able to customize the components of the third trip. This process of spreading a trip to further travellers can keep on going.

This is so powerful. This permissions model can solve many problems.

It is possible to book others' travel.

A contractor may be used for this purpose. The contractor may be instructed “just book it”.

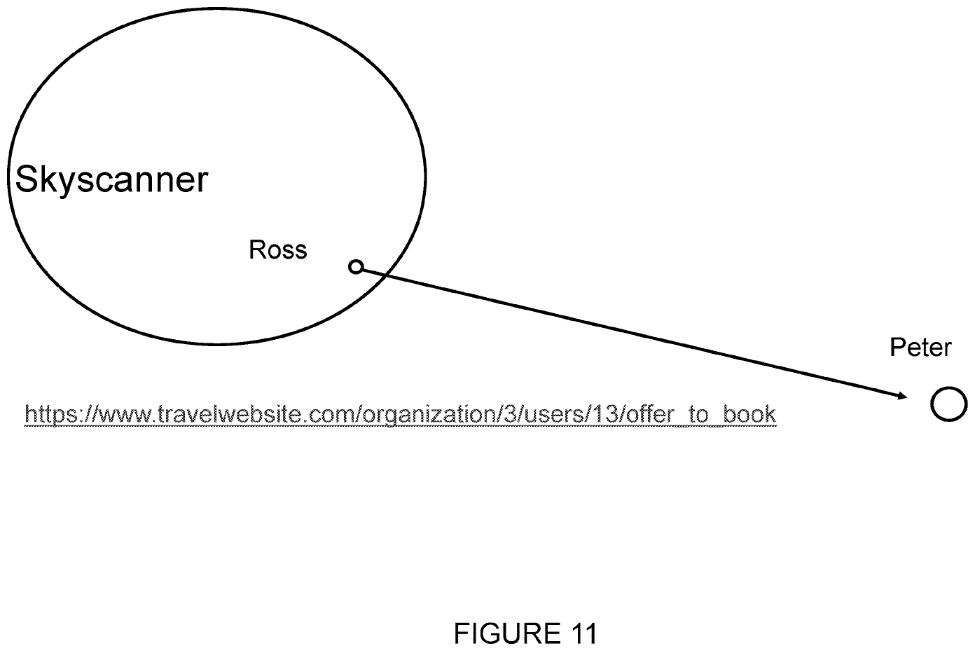

In an example, it is possible to let others book on your account. For example, a user wants to arrange travel through their own organization, for someone else, who may not be in the organization. In an example, a “book your travel link” is offered to the other person, such as by email or text message. An example is shown in FIG. 11, in which Ross in Skyscanner offers a “book your travel link” to Peter, who is not in Skyscanner.

In a response example, the other person who may not be in the organization may select one or more options, which may be based on the policy of the user. In a response example, the other person who may not be in the organization may select one or more options, which may be based on the policy of the user's organization recruitment policy.

How may the organization's hierarchy work in the travel hub? Here is an example. An organization has a name (eg. Skyscanner). The named organization has a hierarchy (eg. departments in the organization, eg. corporate travel group, recruitment). A user (eg. Ross) is situated somewhere in this hierarchy (eg. recruitment). An organization has locations (eg. office locations, eg. Edinburgh office). A user may be associated with a position in a hierarchy, and with an office location. An organization has travel bookers (eg. Jo, from corporate travel group).

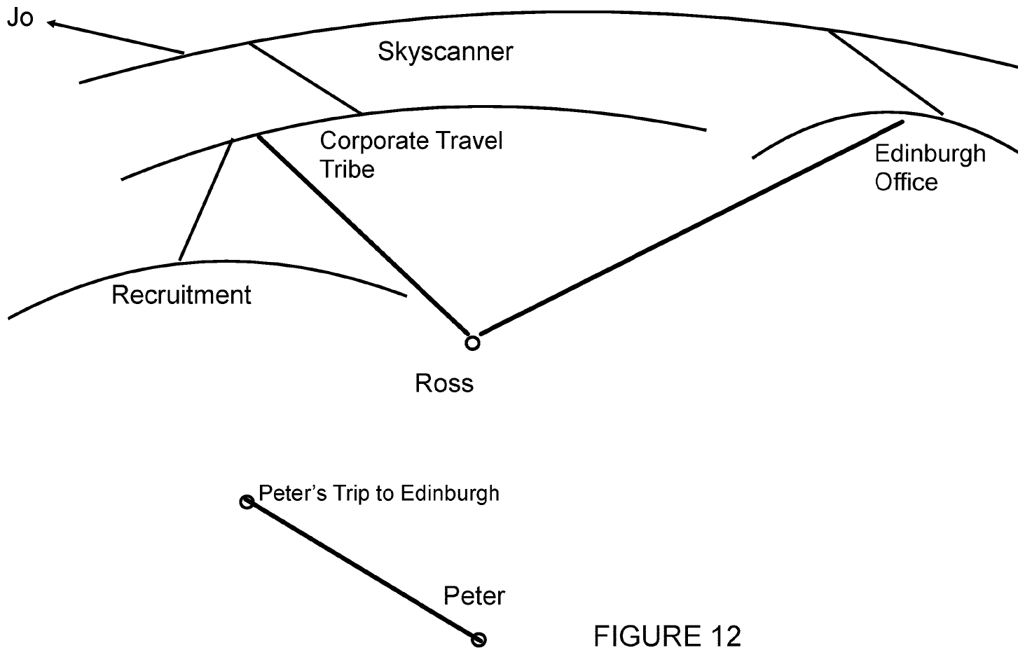

We consider the example of a person outside the organization (eg. Peter); the organization has offered to book that person's travel (eg. Peter's travel to Edinburgh). An example is shown in FIG. 12.

The organization deals with the booking of the person from outside the organization. The trip is assigned to groups in the organization (eg. recruitment, corporate travel group, Edinburgh office).

When an individual in the organization approves the selection, the trip request travels up the organization, looking for the first layer with a booker. The booker may book the trip, and a “booked” status is assigned to the trip. In the travel hub, the trip is centred in the user space of the person outside the organization, but the trip is nevertheless associated with the user space of the organization in the travel hub.

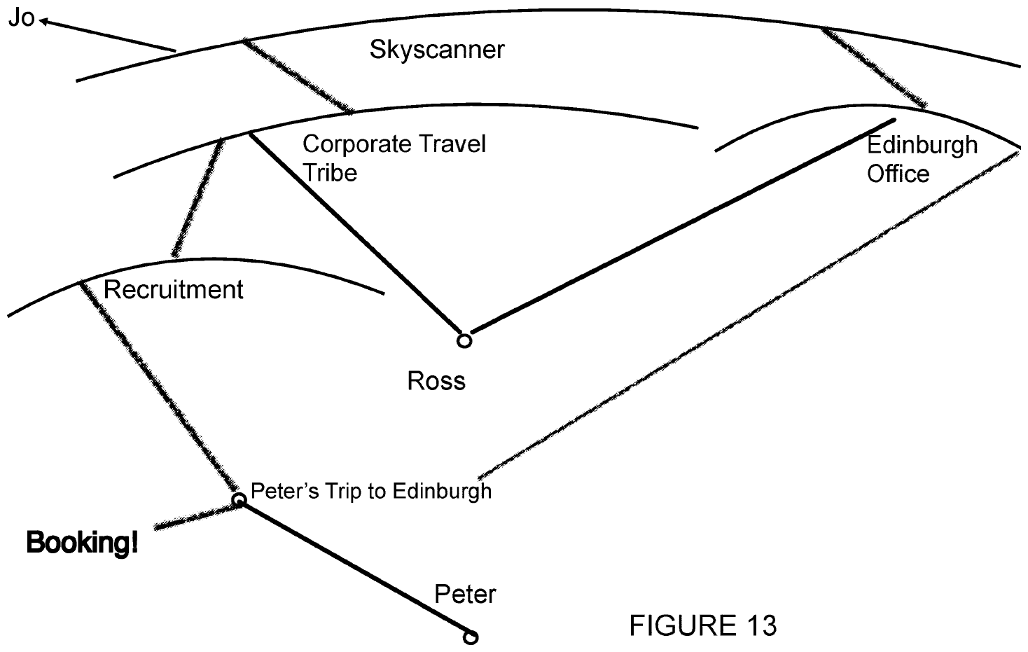

When a supervisor (eg. Shane) looks at reports on the travel hub, he sees the booking his organization paid for, in the correct place. A schematic example is shown in FIG. 13.

An advantage of the travel hub system is its flexibility. An advantage of the travel hub system is it makes it easy for organizations to collaborate. An advantage of the travel hub system is that attending events with others is made simple. An advantage of the travel hub system is that sharing trips is made possible. An advantage of the travel hub system is that booking for others is made possible. An advantage of the travel hub system is that attending events with others from other organizations is made easier for a first organization. An advantage of the travel hub system is that sharing trips or events with others is made very simple.

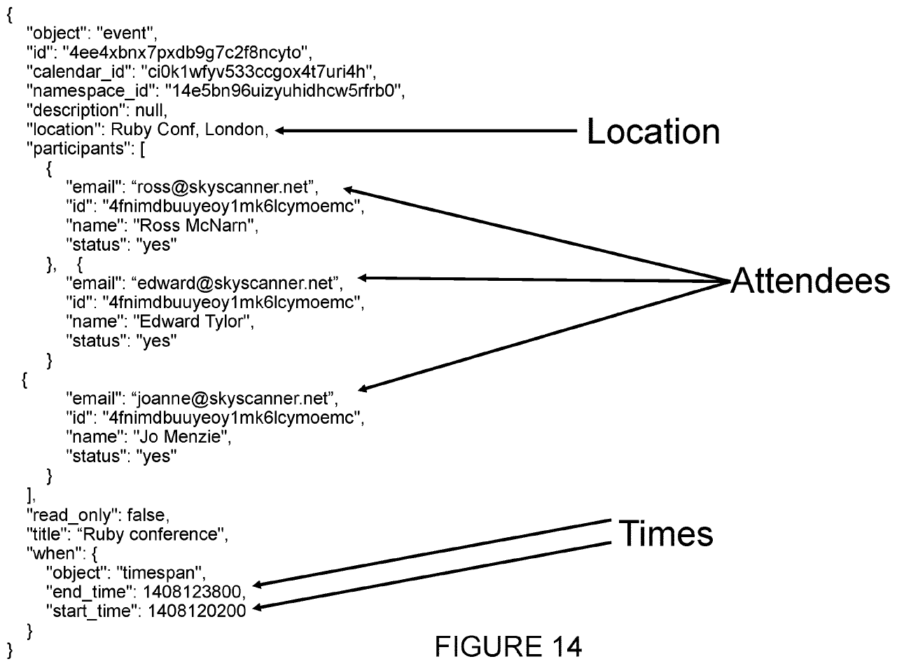

If a user shares a meeting invite (eg. in Microsoft Outlook), the invite may provide a template for collaboration (eg. attendee names and email addresses, a location, and time information eg. a start time and an end time). An example of a meeting invite and information contained in the invite is shown in FIG. 14.

If a user shares their start location (eg. their home address) with the travel hub, that can be saved at the travel hub. Then the travel hub can start to make some guesses of trips, based on received meeting invite information.

If a user remembers one thing, because the calendar is part of their normal workflow, long after they have signed up and forgotten about the travel hub, they can ‘own the calendar’ and re-engage. A user may frequently add calendar events. For calendar events which have a location, the distance from a reference address (eg. the user's home address) may be evaluated, and a reason for the travel hub to contact the user may be understood (eg. some events in Paris on a particular date, some events in London on a different particular date and the user lives in Edinburgh, hence it seems the user will need to travel). The travel hub may help the user to plan, possibly before the user would normally start thinking about travel. The user traveller may be contacted via email, sms, push, or web, for example. The user traveller may be contacted via their smartphone, for example.

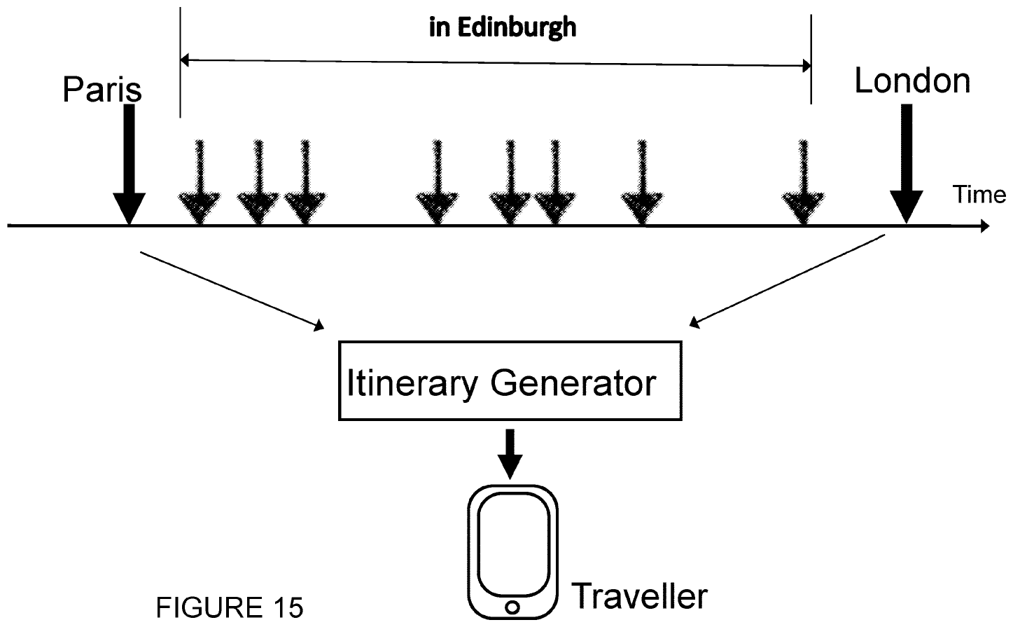

In an example, an itinerary generator may be used by the travel hub to generate and to send possible itineraries to the traveller user, such as to their smartphone. A schematic example is shown in FIG. 15.

An itinerary generator may use Skyscanner technology, for example a Skyscanner itinerary generator. An itinerary generator may generate itineraries according to preferences and a policy.

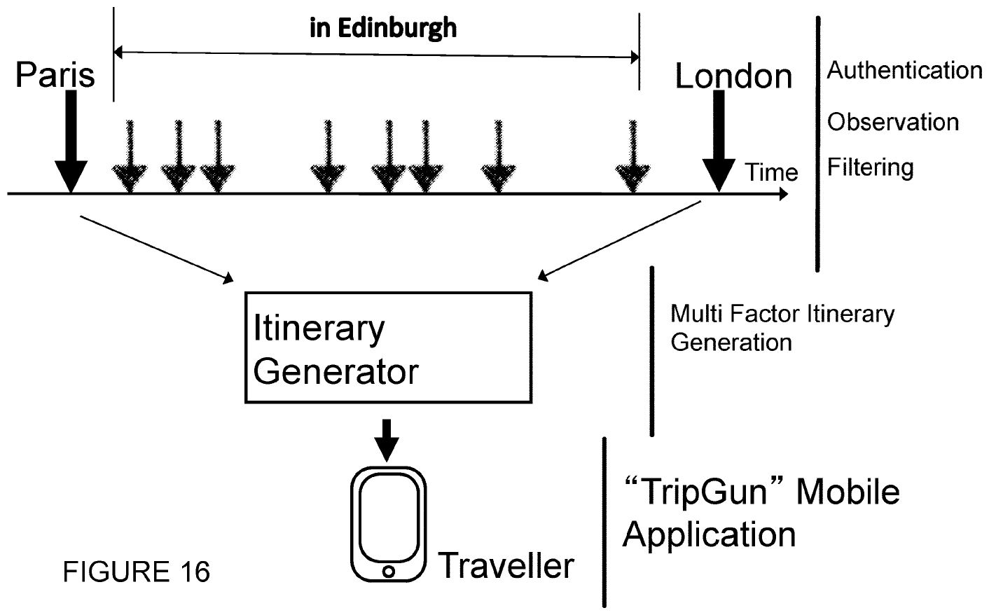

Three services may be provided by or via the travel hub. A first service is Authentication, Observation and Filtering. A second service is Multi Factor Itinerary Generation. A third service is a Mobile Application (eg. “TripGun” Mobile Application). A schematic example is shown in FIG. 16.

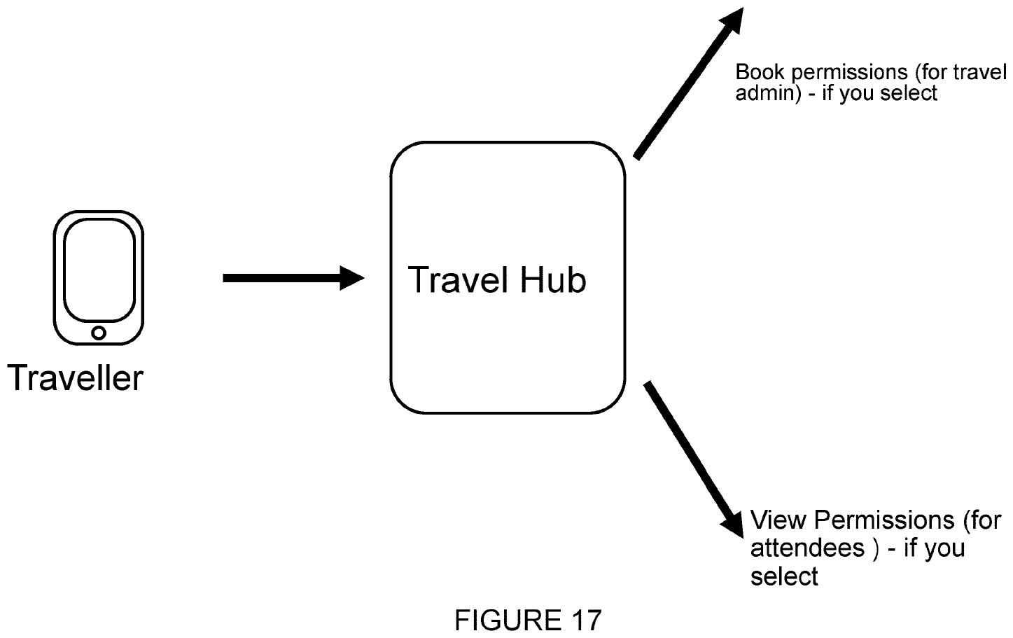

Trips created with a Mobile Application will feed straight into the travel hub. Such trips may be shared, for example as discussed above. A schematic example is shown in FIG. 17.

A mobile device may be in wireless communication with a server. A mobile device may be in wired communication with a server.

### Further Disclosures

1. Raising of a mobile push notifications calling to travel planning action, after creating a calendar event for people that have previously authorized their calendar events to be observed. (In an example, we can scope the time in which engagement takes place to help make it stick e.g. we can select the time in which engagement takes place so as to be suitable for the user).

Example: When the first time Tom opens the mobile device application or fixed device application (“TravelPro”), he is asked if he would like to integrate his calendar with the service. He then selects “yes” and authorizes TravelPro to access his calendar(s) eg. his Google, Outlook, exchange and/or Apple calendar(s). A month later Tom creates a new calendar event with the title “Annual conference” and the location in New York, USA, date 1st June, later in the same year.

Within an hour on his phone a push notification arrives that offers him booking his travel flight and accommodation for the Annual Conference in New York in June. When tapping this notification, the TravelPro application opens and a new trip creation process is started.

2. Visually differentiating accommodation list items from a list of accommodation items, for which a company has negotiated special rates.

Example: When Suzy uses the TravelPro mobile or web application, every time she searches for hotels she sees a list of hotel rows. The hotels that have special rates negotiated by her company are always listed first, with an easy to notice visual differentiation.

3. Visually displaying that a colleague of the current user is staying at or has stayed at accommodations, on a list of accommodation items.

Example: When Joanne uses the TravelPro mobile or web application, every time she searches for accommodations, she sees a list of accommodation items displayed in rows If any of her colleagues have made a booking for that accommodation, she sees their photos or names on these row items. This way she can very easily see which are the accommodations that someone at her company has booked at any point in the past.

4. Visually displaying that a colleague of the current user has booked a flight, on a list of flight items

Example: When James uses the TravelPro web or mobile application, every time he searches for flights, he sees a list of flights items displayed in rows. If any of his colleagues have made a booking for that flight, he sees their photos or names on these row items. This way he can easily see which are the flights that someone at his company has booked at any point in the past.

5. Sorting a list of accommodation items based on their distance from the company office of the current user in the city where these accommodations are located

Example: Tony is using the TravelPro web or mobile application and is searching for accommodation in London. On the screen accommodation result items are displayed in rows. His company has a London office so the accommodation items are sorted from ones closest to this office to the ones furthest from the office.

If Tony searches for accommodation in Edinburgh, where his company has multiple offices, he can choose which office he would like to see accommodations closest to.

6. Visually indicating that a flight item is within the flights policy of the company of the current user

Example: When Joanne is searching for flights with the TravelPro mobile or web application, she sees flight results listed in rows. The flights that have all their parameters—cabin class and price—within the bounds that her company specified, can be visually easily differentiated from the ones that have either of these parameters outside of these bounds.

Joanne is searching for flights from London to New York and her company policy for this route is that prices cannot be over 20% of the median price and can be a maximum of £1000 and for this distance premium economy can be selected. The median price for the economy results is £500. The median price for the premium economy results is £900. Economy results that are more expensive than £600 are marked clearly, as are premium economy results more expensive then £1000. If selecting any of the visually marked flights, she needs to fill out an additional field to explain ignoring the company policy.

7. Visually indicating that a rail item is within the accommodations policy of the current user

Example: When Joanne is searching for rail journey items with the TravelPro mobile or web application, she sees rail results listed in rows. The rail results that have all their parameters—seat class and price—within the bounds that her company specified, can be visually easily differentiated from the ones that have either of these parameters outside of these bounds.

Joanne is searching for rail results from London to Birmingham and her company policy for this route is that prices cannot be over 20% of the median price and can be a maximum of £100 and for this distance first class can be selected. The median price for the economy results is £50. The median price for the first class results is £90. Economy results that are more expensive than £60 are marked clearly, as are first class results more expensive then £100. If selecting any of the visually marked rail results, she needs to fill out an additional field to explain ignoring the company policy.

8. Visually indicating that an accommodation item is within the accommodations policy of the current user

Example: When Barbara is searching for accommodation with the TravelPro mobile or web application, she sees accommodation results listed in rows. The accommodations that have all their parameters—number of hotel stars and price—within the bounds that her company specified, can be visually easily differentiated from the ones that have either of these parameters outside of these bounds.

Joanne is searching for accommodation in London and her company policy for this route is that prices cannot be over 20% of the median price per night and maximum 4 star accommodation can be selected. The median price for the results is £100 per night. The accommodations that are more expensive than £120 per night or that have more than 4 stars are marked visually as outside policy. If selecting any of the visually marked accommodations, she needs to fill out an additional field to explain ignoring the company policy.

Other Ideas
Suggesting people to invite who are in your calendar meetings & are native contacts.
Review a hotel so that it is only visible to the company.
User Interface: When sorting by a parameter, highlighting that parameter on the sorted fields.
User Interface: When tapping disabled search button, fields highlight that need to be filled.

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. A computer-implemented method of sending an itinerary search result to a selected attendee, the method including the steps of:
(i) receiving a selection of a date in a user interface of a computing device, and obtaining events proximate to the selected date from a calendar application executing on the computing device, and presenting in the user interface the events proximate to the selected date;
(ii) providing a selectable option in the user interface to select an itinerary search corresponding at least in part to the presented events obtained from the calendar application;
(iii) receiving a selection of the selectable option;
(iv) sending an itinerary search request to a server, the itinerary search request corresponding to the itinerary search in step (ii);
(v) receiving at the computing device an itinerary search result from the server the itinerary search result corresponding to the itinerary search request in step (iv), and
(vi) presenting the itinerary search result in the user interface on the computing device;
the method further including sending the itinerary search result to an event attendee, including the steps of:
(a) obtaining from the calendar application executing on the computing device a list of attendees from at least one event that overlaps with the itinerary search result, the list of attendees including respective electronic addresses of the attendees;
(b) presenting the list of attendees from the at least one event that overlaps with the itinerary search result;
(c) receiving a selection of an attendee from the list of attendees; and
(d) sending an electronic communication to the selected attendee at a respective electronic address of the selected attendee, in which the communication shares includes the itinerary search result.

2. The method of claim 1, wherein step (iv) includes sending data corresponding to at least one calendar event from the computing device to the server.

3. The method of claim 1, wherein in steps (v) and (vi) a plurality of itinerary search results are received and presented.

4. The method of claim 1, further including step (vii) in which a selectable option is provided in the user interface to request booking of a trip corresponding to the itinerary search result.

5. The method of claim 4, further including step (viii) in which a selection of a booking request for the trip is received.

6. The method of claim 1, wherein the device user interface includes a touch screen.

7. The method of claim 1, wherein the device includes a processor.

8. The method of claim 1, wherein the device is a mobile device.

9. The method of claim 8, wherein the mobile device is a smartphone.

10. The method of claim 1, wherein the server is a remote server.

11. The method of claim 1, wherein the server includes a processor.

12. A computing device programmed to perform a method of sending an itinerary search result to a selected attendee, the computing device programed to:
(i) receive a selection of a date in a user interface of the computing device, and obtain events proximate to the selected date from a calendar application executing on the computing device, and present in the user interface of the computing device the events proximate to the selected date;
(ii) provide a selectable option in the user interface to select an itinerary search corresponding at least in part to the presented events obtained from the calendar application;
(iii) receive a selection of the selectable option;
(iv) send an itinerary search request to a server, the itinerary search request corresponding to the itinerary search in (ii);
(v) receive an itinerary search result from the server, the itinerary search result corresponding to the itinerary search request in (iv), and
(vi) present the itinerary search result in the user interface;
the computing device further programmed to send the itinerary search result to an event attendee, the computing device programmed to:
(a) obtain from the calendar application executing on the computing device a list of attendees from at least one event that overlaps with the itinerary search result, the list of attendees including respective electronic addresses of the attendees;
(b) present the list of attendees from the at least one event that overlaps with the itinerary search result;
(c) receive a selection of an attendee from the list of attendees; and
(d) send an electronic communication to the selected attendee at a respective electronic address of the selected attendee, in which the communication includes the itinerary search result.

13. A system including a server and a computing device, the computing device configured to communicate with the server, the computing device configured to:
(i) receive a selection of a date in a user interface of the computing device, and obtain events proximate to the selected date from a calendar application executing on the computing device, and present in the user interface of the computing device events proximate to the selected date;
(ii) provide a selectable option in the user interface to select an itinerary search corresponding at least in part to the presented events obtained from the calendar application;
(iii) receive a selection of the selectable option;
(iv) send an itinerary search request to the server, the itinerary search request corresponding to the itinerary search in (ii);
(v) receive an itinerary search result from the server, the itinerary search result corresponding to the itinerary search request in (iv); and
(vi) present the itinerary search result in the user interface on the computing device;
wherein the computing device is a user computing device, the system further including a selected attendee computing device configured to communicate with the user computing device, wherein the user computing device is configured to:
(a) obtain from the calendar application executing on the user computing device a list of attendees from at least one event that overlaps with the itinerary search result, the list of attendees including respective electronic addresses of the attendees;
(b) present the list of attendees from the at least one event that overlaps with the itinerary search result;
(c) receive a selection of an attendee from the list of attendees; and
(d) send an electronic communication to the selected attendee computing device at a respective electronic address of the selected attendee, in which the communication includes the itinerary search result.

14. A computer program product embodied on a non-transitory storage medium executable on a computing device including a processor to:
(i) receive a selection of a date in a user interface of the computing device, and to obtain events proximate to the selected date from a calendar application executing on the computing device, and to present in the user interface of the computing device events proximate to the selected date;
(ii) provide a selectable option in the user interface to select an itinerary search corresponding at least in part to the presented events obtained from the calendar application;
(iii) receive a selection of the selectable option;
(iv) send an itinerary search request to a server, the itinerary search request corresponding to the itinerary search in (ii);
(v) receive an itinerary search result from the server, the itinerary search result corresponding to the itinerary search request in (iv); and
(vi) present the itinerary search result in the user interface;
the computer program product further executable to:
(a) obtain from the calendar application executing on the computing device a list of attendees from at least one event that overlaps with the itinerary search result, the list of attendees including respective electronic addresses of the attendees;
(b) present the list of attendees from the at least one event that overlaps with the itinerary search result;
(c) receive a selection of an attendee from the list of attendees; and
(d) send an electronic communication to the selected attendee at a respective electronic address of the selected attendee, in which the communication includes the itinerary search result.

15. The method of claim 1, wherein in steps (v) and (vi), a plurality of itinerary search results are received and presented, and in step (c) the itinerary search result is selected from the plurality of itinerary search results.

16. The method of claim 1, further including step (e) in which a selectable option is provided in the user interface to request booking of a trip.

17. The method of claim 16, further including step (f) in which a selection of a booking request for a trip is received.

18. The method of claim 1, including a step of receiving permission to access the calendar application on the computing device.

19. The method of claim 1, wherein step (b) includes a step of presenting attendee identities in the list of attendees and presenting meetings that fall in an itinerary period.
